(19) United States
(12) Patent Application Publication
(10) Pub. No.: US 2006/0253668 A1
(43) Pub. Date: Nov. 9, 2006

(54) Method and apparatus for preserving operating system and configuration files against a system failure

(76) Inventors: Olaf Borowski, Rocklin, CA (US); James E. Lucari, Meadow Vista, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/120,860

(22) Filed: May 3, 2005

(51) Int. Cl. G06F 12/16

(52) U.S. Cl. 711/162

(57) ABSTRACT

A method for preserving operating system and/or configuration files of a device against a failure includes operatively connecting an external memory to the device, and enabling a processor in the device to automatically synchronize the operating system and/or configuration files in the internal memory of the device with the external memory each time a change occurs in the operating system and/or the configuration of the device. The external memory is a non-volatile memory.

### FIELD OF INVENTION

The present invention relates generally to synchronization or backup of system files, and in particular, to automatic synchronization between an internal memory of a device and a removable external memory.

### BACKGROUND OF THE INVENTION

To avoid loss of system critical files such as operating system (OS) and configuration files, the non-removable internal memory of a computing or network device storing these files is often synchronized, or backed up, on to an external medium. Typically, synchronization or backup is done manually by the user. In the event of a failure, the external medium is used to bring a new device up to the latest known state or configuration of the failed device. Manual backup or synchronization of system critical files, however, places a burden on the user. Some users may not perform this critical process, and even if the files are manually saved, inexperienced users may not have the expertise to reload the stored files necessary to install the operating system, various programs, and the connection settings in the new device.

### SUMMARY OF THE INVENTION

The present invention is directed to a method and system for preserving operating system and/or configuration files of a device against a failure. The features of the present invention includes operatively connecting an external memory to the device, and enabling a processor in the device to automatically synchronize the operating system and/or configuration files in the internal memory of the device with the connected external memory each time a change occurs in the operating system and/or the configuration of the device. The external memory is a non-volatile memory.

### BRIEF DESCRIPTION OF THE DRAWINGS

FIG. 1 is a block diagram illustrating a system for automatically synchronizing system critical files in a device in accordance with one embodiment of the present invention;

FIG. 2 is a flowchart describing a process for automatically synchronizing internal and external memories of the system shown in FIG. 1; and, FIG. 3 is a flowchart describing a startup process for the system shown in FIG. 1.

### DETAILED DESCRIPTION OF THE INVENTION

Broadly stated, the present invention is directed to a system for automatically storing system critical files such as operating system (OS) and configuration files on removable external media. In the event of a device failure, a removable external medium with the latest critical system file is connected to a new device, or the same device after it has recovered from the failure, and bring the device up to the latest known good state. Advantageously, the user connecting the external medium to the device, is not required to know the procedures for configuring the device, but merely connects the external medium to the new or the recovered device.

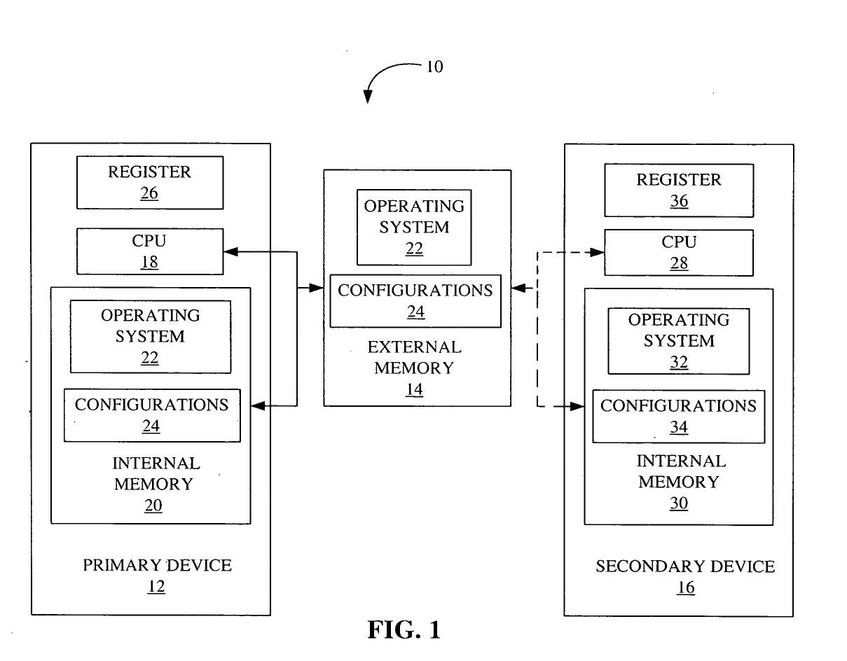

Turning now to FIG. 1, a system 10 for automatically synchronizing, or creating a backup of, system critical files such as operating system (OS) and configuration files in accordance with one embodiment of the present invention includes a primary device 12 and an external memory 14. The external memory 14 is configured to be disconnected from the primary device 12 and removably connected to a secondary device 16. The connection between the primary device 12 and the external memory 14 may be made through a communication cable such as a computer disk interface cable or electro-mechanical links, or connected together directly through a docking mechanism such as, for example, a compact flash interface that is able to interface with the CPU 18.

The primary device 12 may be a computing device or a network device such as, for example, a PC, a router, a hub, a switch, or a CD-ROM driver, and includes a central processing unit (CPU) 18 and an internal memory 20 for storing files used by the CPU including an operating system file 22 and configuration files 24 for enabling external interfaces, special diagnostics, or security mechanisms, for example. A register 26 in the form of a fixed memory such as an EPROM, for example, is also included in the primary device 12.

The external memory 14 in one embodiment is a removable mass storage device such as a CompactFlash® card. However, other memory devices such as universal serial bus (USB), compact disk, or other such recording or memory devices may also be employed. The external memory 14 is configured to be in communication with the CPU 18 and the internal memory 20 of the primary device 12, and stores system critical files such as the OS file 22 and configuration files 24 of the primary device 12. The external memory 14, accordingly, is a non-volatile memory device.

The secondary device 16 may be the same type of device as the primary device 12, or any other device that is capable of operating using the operating system and the configurations of the primary device. The secondary device 16 may also be the primary device 12, itself, after recovering from a system failure. The secondary device 16 also includes a CPU 28, an internal memory 30 for storing at least an operating system file 32 and system configurations files 34, and a register 36. These components of the secondary device 16 perform the same functions described with respect to the components (the CPU 18, internal memory pad and register 26) of the primary device 12. As described in more detail below, the external memory 14 automatically stores the system critical files of the primary device 12, and when required, enables the secondary device 16 to operate using the stored files.

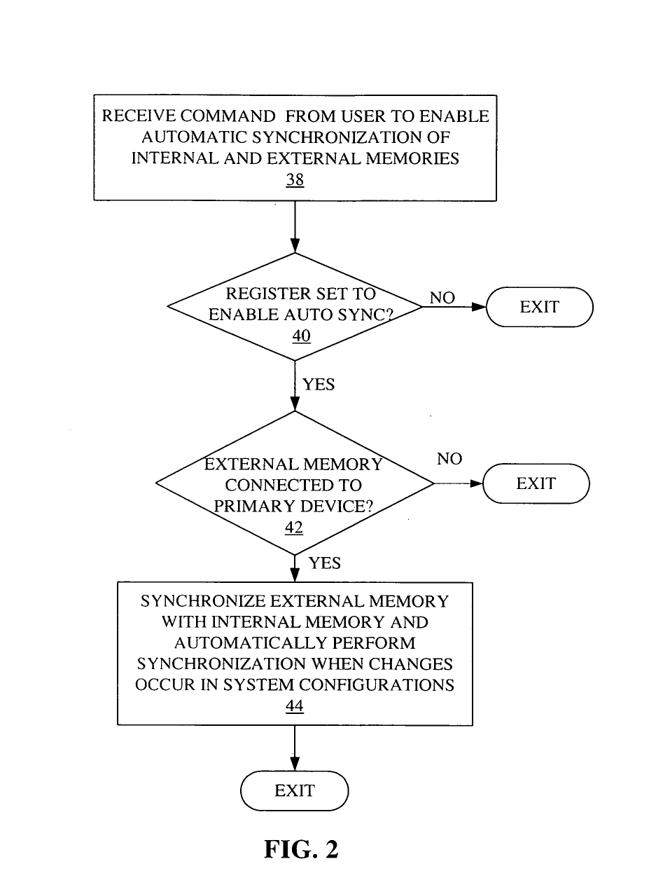

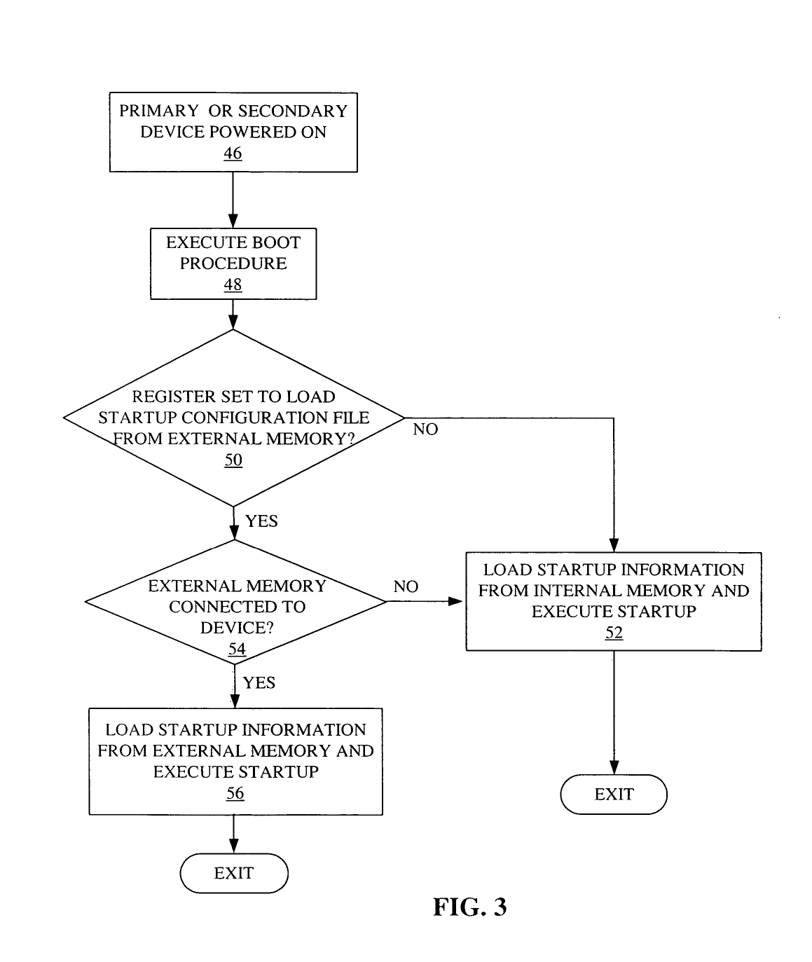

Turning now to FIG. 2, the automatic synchronization feature of the system 10 is initiated when the CPU 18 of the primary device 12 receives a command from a user enabling automatic synchronization between the external memory 14 with the internal memory 20 (block 38). In one embodiment, this command is issued by the user when any command is issued using command line interface (CLI) instructions or other known interfaces that alter the existing configuration or operating system. When the CPU 18 receives this command, it checks the register 26 to determine whether it is preset to enable automatic synchronization (block 40). If the register 26 is not set to enable automatic synchronization, the process ends without performing the automatic synchronization process.

If the register 26 is preset to enable automatic synchronization, the CPU 18 further determines whether the external memory 14 is connected to the primary device 12 (block 42) by performing a status check of the removable memory. If not, the process ends without performing the automatic synchronization procedure. If, however, the external memory 14 is connected to the primary device 12, the CPU 18 synchronizes the external memory with the internal memory 20, and automatically perform the synchronization thereafter any time there is a change in the configuration or operating system software of the primary device 12 (block 44). In one embodiment, the CPU 18 simultaneously updates the OS 22 and configuration 24 files in both the internal memory 20 and the external memory 14 to automatically synchronize these files. In another embodiment, the CPU 18 first updates the files 22, 24 in the internal memory 20 and then copies the files of the internal memory to the external memory 14.

The automatic synchronization feature of the present invention allows the external memory 14 to be used to reload the operating system and the latest known configurations in the primary device 12 when the primary device suffers a failure, since the external memory will have retained the last known good states of the primary device. In the event of a hardware failure of the primary device 12, the external memory 14 can also be used to load the latest known configuration states and the operating system of the primary device in secondary or replacement device 16. One advantage of the present invention is that the user does not require a technical expertise in order to load the necessary files from the external memory 14 in the restarted primary device 12 or the newly installed secondary device 16, since the files are automatically loaded when the primary or the secondary devices are initially powered on.

More specifically and referring to FIG. 3, when the primary device 12 or the secondary device 16 has been powered on (block 46), the CPU 18 executes a boot to procedure in which the register 26 or 36 is accessed to determine whether it has been set to load startup configurations from the removable memory 14 (block 48). It should be understood that it does not matter whether the device being powered on is the primary device 12 or the secondary device 16, since they both operate in an identical matter. As an example, it is assumed that the device that has powered on is the primary device 12.

Still referring to FIG. 3, if the register 26 of the primary device 12 is not set to load startup configurations from the removable memory 14 (block 50), the CPU 18 retrieves the necessary startup information from the internal memory 20 and executes a startup process (block 52). If the register 26 is set to indicate that the startup configuration files should be retrieved from the external memory 14 (block 50), the CPU 18 determines whether the external memory 14 is connected to the primary device 12 being powered on by performing a status check of the removable memory (block 54). If the external memory 14 is not connected, the CPU 18 retrieves the startup configuration files 24 from the internal memory 20 and executes a startup process based on the retrieved files (block 52). However, if the external memory 14 is connected to the device being powered on, (block 54) the CPU 18 retrieves the necessary startup information from the external memory 14 and executes a startup process (block 56).

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A method for preserving operating system and/or configuration files of a primary device against a system failure, comprising:
operatively connecting an external memory to the primary device; and,
enabling a processor in the primary device to automatically synchronize the operating system and/or configuration files in an internal memory of the primary device with the external memory each time a change occurs in the operating system and/or the configuration of the primary device;
wherein the external memory is a non-volatile memory.

2. The method as defined in claim 1, further comprising:
connecting the external memory to a second device; and,
enabling a processor in the second device to automatically load the operating system and/or configuration files from the external memory in the second device when the second device is powered on.

3. The method as defined in claim 1, further comprising:
automatically loading the operating system and/or configuration files from the external memory in the primary device when the device is powered on after a failure.

4. A system for preserving operating system and/or configuration files of a first device against a system failure, comprising:
an internal memory provided in the first device for storing the operating system and/or configuration files;
an external memory operatively and removably connected to the first device for storing the operating system and/or configuration files of the first device; and,
a processor provided in the device for automatically synchronizing said internal memory with said external memory so that said internal memory and said external memory store the same operating system and/or configuration files;
wherein the operating system and/or configuration files in the external memory is automatically loaded in the first device when the first device is powered on after a failure, or in a second device when said second device is powered on.

5. The system as defined in claim 4, further comprising:
a register provided in said device for enabling said processor to perform the automatic synchronization.

6. The system as defined in claim 5, wherein said external memory comprises a non-volatile memory.

7. The system as defined in claim 6, wherein said external memory comprises a CompactFlash® card.

8. The system as defined in claim 4, wherein said external memory is operatively connected said second device when said second device is powered on to automatically load the operating system and/or configuration files in the external memory

9. The system as defined in claim 8, wherein said external memory is disconnected from said first device when the operating system and/or configuration files in the external memory is loaded in said second device.
